(19) United States
(12) Patent Application Publication
(10) Pub. No.: US 2006/0285819 A1
(43) Pub. Date: Dec. 21, 2006

(54) Creating edit effects on mpeg-2 compressed video

(75) Inventors: Declan Patrick Kelly, Eindhoven (NL); Jan Alexis Daniel Nesvadba, Eindhoven (NL); Jozef Pieter Van Gassel, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/546,720

(22) PCT Filed: Nov. 28, 2003
(86) PCT No.: PCT/IB03/05589

§ 371 Date: Aug. 24, 2005

(30) Foreign Application Priority Data
Dec. 20, 2002 (EP) 02080531.3

(51) Int. Cl. H04N 5/93

(52) U.S. Cl. 386/52

(57) ABSTRACT

A method and apparatus for creating edit effects on compressed video data is disclosed. First, an edit point is selected. Two anchor pictures on each side of the edit point are then selected. A series of frames is created to create an edit transition at the edit point. The series of frames can be B-picture frames, I-picture frames, or B-picture frames which contain Intra-coded macroblocks.

The invention relates to editing of video content, and more particularly to a method and apparatus for implementing editing transitions on compressed video without needing to fully decode and recode the video stream.

Due to the increase in the demand for video products such as digital cameras, camcorders and storage devices (DVDs), digital video editing is becoming increasingly popular. Video editing effects are needed to enhance the quality of the video production. Most video editing can be divided into two major categories: abrupt transitions and gradual transitions. Gradual transitions include camera movements: panning, tilting, zooming and video editing special effects: fade-in. fade-out, dissolving, wiping. Abrupt transition is the simplest edit between two shots in which the transition is immediate between two frames.

Special effects occur gradually over multiple frames. Though, the number of possible video special effects is quite high in video production, most of these special effects fall into several categories, such as fading, dissolving or wiping. During a fade, the intensity gradually decreases to, or increases from, a solid color. In a dissolve, two shots are additively mixed, wherein one increases in intensity, and the other decreases in intensity. Wipes are generated by translating a line across the frame in some direction, where the content on each side of the line belongs to the two pictures separated by the edit. All these special effects are used to produce gradual transitions between two scenes. These video editing tools are designed for spatial domain processing.

The large channel bandwidth and memory requirements for the transmission and storage of image and video necessitate the use of video compression techniques. A compression standard referred to as MPEG (Moving Pictures Experts Group) compression is a set of methods for compression and decompression of full motion video pictures which uses an inter-picture compression technique. Intra-pictures are referred to as I-pictures. The inter-pictures are divided into two groups: inter-pictures coded using only past reference elements which are referred to as P-pictures and inter-pictures coded using a past and/or future reference, referred to as B-pictures. Hence, the visual data in multimedia databases is expected to be stored mostly in the compressed form. Thus, editing of compressed video is also essential. Therefore, a typical desktop video editing system must first convert the compressed domain representation to a spatial domain representation and then perform the editing function on the spatial domain data. Then, the output of the editing system must be recompressed. This decoding, processing and subsequent re-encoding is time consuming and a drain on system resources.

It is an object of the invention to overcome the above-described deficiencies by providing a method and apparatus for providing edit effects on compressed video with less decoding and re-encoding. The system introduces edit effects without modifying the original video streams by introducing fixed bit patterns between two sequences to generate the effects or copy and modify the coded version of the picture wherein all processing is done in the compressed domain.

According to one embodiment of the invention, a method and apparatus for creating edit effects on compressed video data is disclosed. First, an edit point is selected. Two anchor pictures on each side of the edit point are then selected. A series of frames is created to create an edit transition at the edit point. The series of frames can be B-picture frames, I-picture frames, or B-picture frames which contain Intra-coded macroblocks.

These and other aspects of the invention will be apparent from and elucidated with reference to the embodiments described hereafter.

The invention will now be described, by way of example, with reference to the accompanying drawings, wherein:

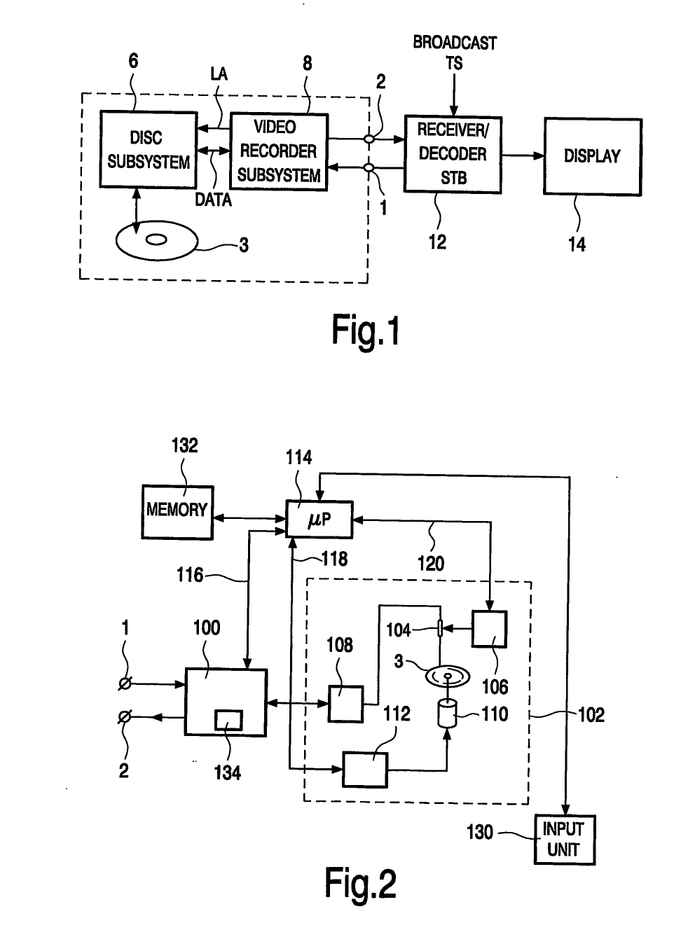

FIG. 1 illustrates a block diagram of a audio-video apparatus suitable to host embodiments of the invention;

FIG. 2 illustrates a block diagram of a set-top box which can be used to implement at least one embodiment of the invention;

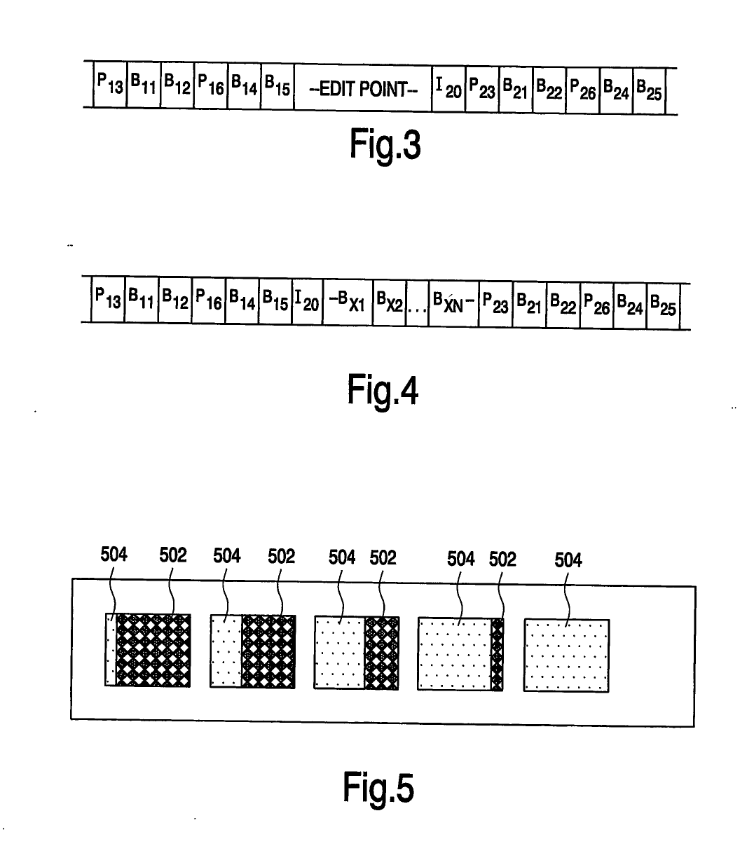

FIG. 3 is a diagram of a video stream illustrating an edit point according to one embodiment of the invention;

FIG. 4 is a diagram of an edited video stream according to one embodiment of the invention;

FIG. 5 illustrates a vertical wipe operation according to one embodiment of the invention;

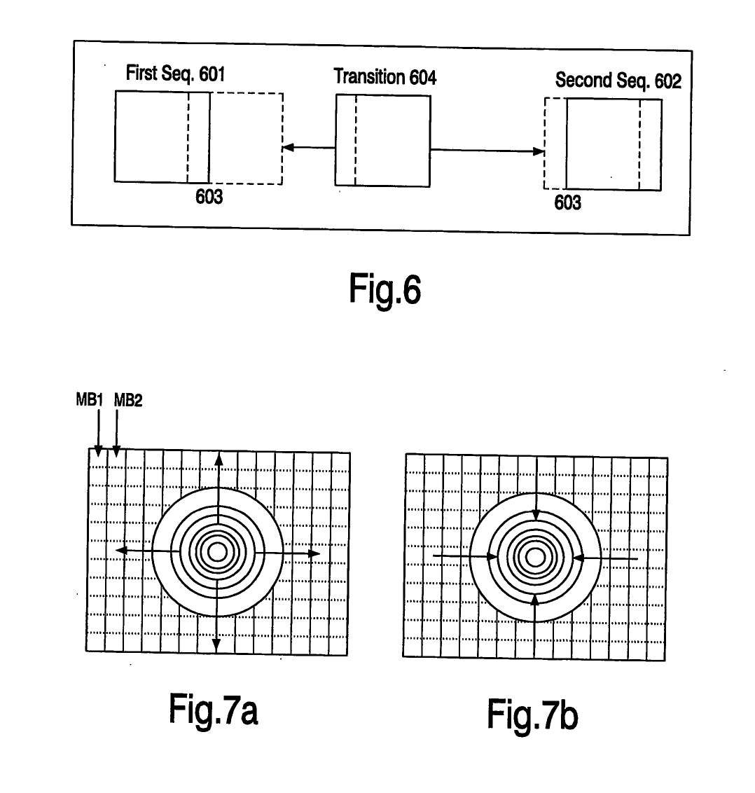

FIG. 6 illustrates how macroblocks along a transition are created from original blocks according to one embodiment of the invention;

FIGS. 7(a)-(b) illustrate circular wipes according to one embodiment of the invention; and

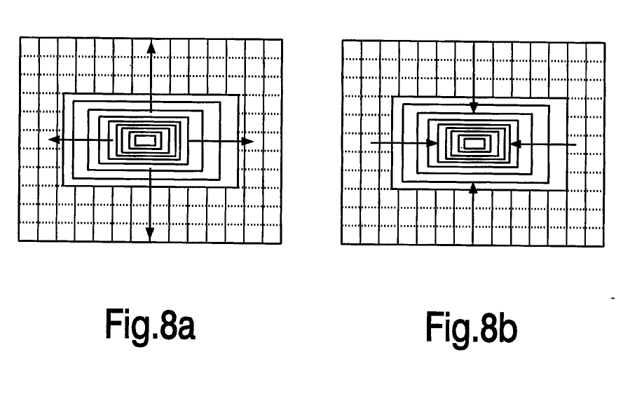

FIGS. 8(a)-(b) illustrate rectangular wipes according to one embodiment of the invention.

According to one embodiment of the invention, edit effects on compressed video streams are provided with less decoding and re-encoding than conventional methods. Such effects can then be included when an edited sequence is played back over a digital interface because the output of the edit operation is a valid video stream. The operations can be generated as part of the interface processing and don't need to be created off-line and stored on disc.

The invention will be elucidated by describing an embodiment of the invention where video data is compressed according to the MPEG-2 (Motion Pictures Expert Group) standard. According to this standard, a compressed video stream is built up from intra-coded frames, also known as I-frames, and inter-coded frames. The inter-coded frames can either point back to a frame in the compressed video stream, these are so-called B-frames or point back as well as forward to frames in the compressed video stream, these are so-called P-frames.

The frames are divided in macroblocks and the inter- and intra-coding as well as backward and forward pointing is done on macroblock level. MPEG-2 is based on motion estimation, meaning a macroblock in a B-frame at a first location in the B-frame can point to a second location in a preceding I-frame.

In one embodiment of the invention, it is assumed that the first sequence ends with a P-frame or an I-frame as the last displayed frame and the second sequence starts with an I-frame. This can be achieved by ignoring some extra frames. If necessary, it is possible to choose the last picture of the first sequence to be an I-frame, by again discarding other unwanted pictures.

As mentioned above, edit effects can be introduced without modifying the original video streams by introducing fixed bit patterns between the two sequences to generate the effects, or copying and modifying the coded version of the picture wherein all processing is performed in the compressed domain.

As will be described below, combinations of these two approaches are also possible in a single transition where some macroblocks are coded using only motion vectors while others are created by copying and modifying the original pictures. Using these techniques, standard editing effects such as wipes, fade out, cross-fade, etc., are provided. Also, other editing effects can be provided that are not normally found in analogue video processing but because of the nature of MPEG-2 coding can be generated.

FIG. 1 illustrates an audio-video apparatus suitable to host the invention. The apparatus comprises an input terminal 1 for receiving a digital video signal to be recorded on a disc 3. Further, the apparatus comprises an output terminal 2 for supplying a digital video signal reproduced from the disc. These terminals may in use be connected via a digital interface to a digital television receiver and decoder in the form of a set-top box (STB) 12, which also receives broadcast signals from satellite, cable or the like, in MPEG TS format. The set-top box 12 provides display signals to a display device 14, which may be a conventional television set.

The data area of the disc 3 consists of a contiguous range of physical sectors, having corresponding sector addresses. This address space is divided into sequence areas, with a sequence area being a contiguous sequence of sectors. The video recording apparatus as shown in FIG. 1 is composed of two major system parts, namely the disc subsystem 6 and the video recorder subsystem 8, controlling both recording and playback. The two subsystems have a number of features, as will be readily understood, including that the disc subsystem can be addressed transparently in terms of logical addresses (LA) and can guarantee a maximum sustainable bit-rate for reading and/or writing data from/to the disc.

Suitable hardware arrangements for implementing such an apparatus are known to one skilled in the art, with one example illustrated in patent application Ser. No. WO-A-00/00981. The apparatus generally comprises signal processing units, a read/write unit including a read/write head configured for reading from/writing to a disc 3. Actuators position the head in a radial direction across the disc, while a motor rotates the disc. A microprocessor is present for controlling all the circuits in a known manner.

FIG. 2 shows an embodiment of the apparatus in accordance with the invention. The apparatus comprises an input terminal 1 for receiving an information signal and a signal processing unit 100. The signal processing unit 100 receives the video information signal via the input terminal 1 and processes the video information into an information file for recording the information file on the disc 3. Further, a read/write unit 102 is available. The read/write unit 102 comprises a read/write head 104, which is in the present example an optical read/write head for reading/writing the information file on/from the disc 3. Further, positioning means 106 are present for positioning the head 104 in a radial direction across the disc 3. A read/write amplifier 108 is present in order to amplify the signal to be recorded and amplifying the signal read from the disc 3. A motor 110 is available for rotating the disc 3 in response to a motor control signal supplied by a motor control signal generator unit 112. A microprocessor 114 is present for controlling all the circuits via control lines 116, 118 and 120. An input unit 130 allows a user to select an edit point in the video data where the edit transition will be added.

The signal processing unit 100 is adapted to convert the video data received via the input terminal 1 into blocks of information in the channel signal: the size of the blocks of information can be variable but may, for example, be between 2 MB and 4 MB. The write unit 102 is adapted to write a block of information of the channel signal in a sequence area on the disc 3. The information blocks corresponding to the original video signal are written into many sequence areas that are not necessarily contiguous, which is known as fragmented recording. As will be described below, the signal processing unit 100 creates the edit transitions in accordance with the various edit operations.

According to one embodiment of the invention, a transition between two pictures is created by inserting new pictures which use motion vectors which reference the original pictures. The inserted new pictures are B-pictures and therefore can refer to the old anchor picture, the new anchor picture or both pictures. Because motion vectors are defined per macroblock, each macroblock can be chosen from either the old picture, the new picture or a combination of both.

If the original sequence includes B-pictures then there is a problem if a sequence of B-pictures is inserted. Because of the picture re-ordering, the final I/P picture in the first sequence will be displayed after the inserted B-pictures. To deal with this, the first I-picture of the second sequence can be placed before the set of inserted pictures. For example, suppose the original stream is as illustrated in FIG. 3, wherein the edit point occurs between B₁₅ and I₂₀. According to the invention, the I-picture I₂₀ is inserted before the edit point and the edit transition is generated by frames B_{X1} B_{X2} . . . B_{Xn} which is illustrated in FIG. 4.

By generating a sequence of B-pictures with specific motion vectors, a transition can be created between the two original pictures. The sequence of B-pictures to be inserted is independent of the content of the original pictures and so the same sequence of B-pictures will generate the same effect independent of the content of the original pictures. The size of the inserted B-pictures will be very small resulting in a low average bit rate.

A wipe operation is a transition from one picture to another which can be performed horizontally, vertically or diagonally. For example, FIG. 5 illustrates a vertical wipe. To perform a wipe in MPEG-2, each macroblock is chosen from either the first or the second anchor picture. Because of restrictions in MPEG-2 coding (motion vectors must not point outside the coded part of the picture), the wipe is implemented block by block. This kind of wipe effect can be implemented using B-pictures to choose the blocks from either the first or second anchor picture.

For example, to implement a wipe from the left side of the picture as illustrated in FIG. 5, initially all the blocks are taken from the first anchor picture 502. Then at the next stage in the wipe, all left-most macroblocks are taken from the second anchor picture 504 and the rest of the macroblocks are taken from the first anchor picture 502. In the next step an additional row of blocks are chosen from the second anchor picture 504 and so on until the first anchor picture 502 has been replaced by the second anchor picture 504. By repeating the inserted B-pictures a number of times, the speed of the wipe can be controlled.

There are several variations of this wipe effect. In the first variation, the second anchor picture replaces the first anchor picture but all blocks are shown in their normal position on the screen (and so all motion vectors are zero). The second variation is performed by showing the rightmost column of blocks from the second anchor picture in the left most column and then the blocks from the second anchor picture push across the first anchor picture. Similarly, the second anchor picture can appear to push the first anchor picture off the screen, i.e., the blocks move one position to the right for each iteration. Variations of this are also possible, e.g., the new picture appears to push across while the old picture appears stationary.

In this illustrative example, the wipe is performed on a block by block basis and not in a smooth pixel-by-pixel basis. Another variation is to use bidirectional B-pictures to merge the blocks of the old and new pictures, i.e., B-picture then points to a block from the first picture and a block from the second picture, this means that during the wipe the blocks are merged before the second picture replaces the first. Similarly, these wipe effects can be done in the horizontal direction.

Other wipe variants are also possible, e.g., wipe from both left and right (or top and bottom) and meet in the middle. In addition, a wipe can start in a top corner and expand through the complete picture in a diagonal manner. It is also possible to wipe the even macroblock rows from the left and then the odd macroblock rows from the right or do both in parallel from opposite directions. Similar operations can also be performed for horizontal wipes.

For cellular automata style transitions, a few blocks from the old picture are replaced with blocks from the new picture. Then, based on a predetermined rule further blocks are replaced on each successive iteration. For example, a replacement rule could be a rule where any block that is adjacent to an already replaced block is replaced. This gives the impression of the new picture growing out of the old picture. This can be performed using motion vectors of size zero pointing to either the old picture or the new picture. In this way, the same block in the other picture is chosen. A variation of this operation is where the block in the old picture is replaced by a combination of the block at the same location in both the old and new picture (done by having two motion vectors which are both zero) and then in the next iteration it is replaced by the block from the second picture.

For effects using manipulation of intra-coded pictures, transitions are generated by copying and manipulating the intra-coded blocks. This can involve manipulating the old and new pictures independently or combining the two together. The two original pictures should both be I-pictures and the inserted pictures are also coded as I-pictures. The discrete cosine transform (DCT) coefficient blocks of the two original pictures are manipulated to cause edit transitions. While this embodiment involves VLC decoding and encoding, the coding has a much lower complexity than full MPEG-2 decoding and encoding. Inserting a sequence of I-frames may increase the bit-rate but some solutions are: insert empty P-frames to cause copying and reduce the average bit-rate and also slow down the speed of the fade; increase the quantiser scale of the I-frame to reduce the coded bits. In general, the edit effect involves transitions to pictures that can be easily coded so the number of bits required will be less later in the transition.

A fade out operation can be performed by copying the I-frame a number of times and each time reducing the size of all coefficients by a predetermined factor, wherein the size of the reduction determines the speed of the transition. As the picture fades out, the number of bits needed should reduce very quickly. Similarly, a fade-in operation is performed in the opposite way. Fade out can also be combined with other effects. Fade out with blurring can be achieved by throwing away the higher frequency components in the macroblocks. Fade to Black-and-White followed by fade out can be achieved by first (gradually) reducing the chroma components before starting to reduce the luminance component.

For a cross-fade operation, a smooth transition from the first sequence to the second sequence is generated. As with fade to Black, cross fade can be performed by operating on the DCT coefficients of the I-frames. Basically, the DCT coefficients from the two I-frames are added as follows: a*DCT₁+(I-α)*DCT₂ where a starts at 0 and progresses to 1. The duration of the transition can be changed by choosing the speed to increase the coefficient α.

For a DC Cross-Fade operation, the old picture is faded to a DC only value, i.e., in each successive picture more AC coefficients are removed. In addition, a factor of the DC coefficient of the new picture can be added so the result is the average of the two DC values. Then, the DC coefficient of the first picture can be faded out while adding the AC coefficients of the new picture. Variations of this operation can be created by performing this with the chromenence (U,V) coefficients first or else fading these to a specific value. A third variation is to fade first between the U,V coefficients using (α, 1-α) so that the old picture luminance is combined with the new picture chromenence and then fade to the new picture luminance.

It is also possible to create edit effects that combine using both motion vectors and the manipulation of intra coded blocks at the same time. In this case, the inserted pictures will be B-pictures with some Intra-coded macroblocks. As described above, a wipe occurs where a transition from one picture to another is performed either horizontally or vertically. FIG. 6 illustrates how macroblocks along the transition are created from the original blocks. The chosen parts of the pictures from the first sequence 601 and the second sequence 602 are combined (in the decoded domain) and the blocks are re-encoded as Intra-coded blocks. Other macroblocks are copied directly from the previous or next picture. Because the MPEG-2 standard explicitly excludes motion vectors that point outside the picture, it is necessary to re-encode (intra) these blocks along the transition 604. As illustrated in FIG. 6, there is a hard break 603 between the two pictures. It is also possible to have some overlapping pixels between the two pictures to give an averaging effect along the transition.

Several variations of this wipe are possible. In the first case, the new picture pushes the old picture from the screen. In the second case, the new picture overwrites the old picture but there is no change in the position on screen of the old picture. Other wipe variants are also possible, e.g., wipe from both left and right (or top and bottom) and meet in the middle. Wipe from top corner and expand through complete picture. It is also possible to wipe the even macroblock rows from the left and the odd macroblock rows from the right or do both in parallel from opposite directions.

For circular wipes, the new picture appears from a point in the center and replaces the old picture by outwardly expanding circles as illustrated in FIG. 7(a). The opposite case where the new picture appears in a circle on the edges and moves to a point is also possible and is illustrated in FIG. 7(b). It will be understood that when these images are displayed, the transition may in some cases appear elliptical and not circular.

For macroblocks either completely inside or outside the circle, there is no problem, they will be taken from either the old picture or new picture by using vector motion. For macroblocks on the circle, it is necessary to decode the two blocks and then choose the appropriate pixels from the old and new pictures to create the circular effect and then re-encode the block as an Intra-coded block. By re-encoding the blocks on the circle, a clean break at the transition point can be achieved. It is also possible, for example, to just combine the two blocks (using motion vectors to both blocks) to give an un-smooth blurred transition. A similar effect but with the new picture coming from a point in the middle but expanding as a rectangle and starting at the edges and moving inward to the center is also possible as illustrated in FIGS. 8(a)-(b). Again in this case, the blocks around the border must be re-encoded to get a clean break.

It will be understood that the different embodiments of the invention are not limited to the exact order of the above-described steps as the timing of some steps can be interchanged without affecting the overall operation of the invention. Furthermore, the term “comprising” does not exclude other elements or steps, the terms “a” and “an” do not exclude a plurality and a single processor or other unit may fulfill the functions of several of the units or circuits recited in the claims.

The invention can be summarised as method and apparatus for creating edit effects on compressed video data is disclosed. First, an edit point is selected. Two anchor pictures on each side of the edit point are then selected. A series of frames is created to create an edit transition at the edit point. The series of frames can be B-picture frames, I-picture frames, or B-picture frames which contain Intra-coded macroblocks.

1. A method for creating edit effects on compressed video data, comprising the steps of:
selecting an edit point;
selecting two anchor pictures on each side of the edit point;
creating a series of frames to create an edit transition at the edit point.

2. The method according to claim 1, wherein the series of frames are B-picture frames.

3. The method according to claim 2, wherein the series of B-picture frames reference a first anchor picture, a second anchor picture or a combination of the first and second anchor pictures.

4. The method according to claim 2, wherein the edit effect is a wipe.

5. The method according to claim 2, wherein the edit effect is a fade.

6. The method according to claim 3, wherein each macroblock of the edited image is chosen from the first anchor picture, the second anchor picture or a combination of the first and second anchor pictures.

7. The method according to claim 6, wherein motion vectors are defined on a per macroblock basis.

8. The method according to claim 4, wherein the wipe effect is created by selecting macroblocks on a first side of the transition from the first anchor picture and selecting macroblocks on a second side of the transition from the second anchor picture.

9. The method according to claim 8, wherein macroblocks on the second side of the transition are shown in a location which corresponds to their final position in a resulting picture.

10. The method according to claim 8, wherein the macroblocks of the second anchor picture appear to push across the first anchor picture.

11. The method according to claim 8, wherein the second anchor picture appears to push the first anchor picture off a screen.

12. The method according to claim 4, wherein the wipe is performed in a vertical, horizontal or diagonal direction.

13. The method according to claim 12, wherein the wipe is started on two sides of the first anchor picture and meet in the middle of the first anchor picture.

14. The method according to claim 6, wherein macroblocks from the first anchor picture are randomly replaced by corresponding blocks in the second anchor picture.

15. The method according to claim 6, further comprising the steps of:
randomly replacing macroblocks from the first anchor picture with a combination of the corresponding macroblocks in the first and second anchor pictures;
replacing the combination macroblocks with the corresponding macroblocks from the second anchor picture.

16. The method according to claim 1, wherein the series of frames are I-picture frames.

17. The method according to claim 16, wherein DCT coefficient blocks of the two anchor pictures are manipulated in the series of I-picture frames to create the edit transition.

18. The method according to claim 17, wherein the edit effect is a fade.

19. The method according to claim 18, wherein the fade effect is created by reducing the size of all DCT coefficients by a predetermined factor in each successive I-picture frame of the edit transition.

20. The method according to claim 17, wherein DCT coefficients of a first anchor picture are reduced to zero and DCT coefficients of a second anchor picture are increased from zero to their actual values in each successive I-picture frame of the edit transition.

21. The method according to claim 1, wherein the series of frames are B-picture frames which may contain Intra-coded macroblocks.

22. The method according to claim 21, wherein the Intra-coded macroblocks are for macroblocks which form a transition between the images of the two anchor pictures.

23. An apparatus for creating edit effects on compressed video data, comprising:
means (130) for selecting an edit point;
means (100) for selecting two anchor pictures on each side of the edit point;
means (100) for creating a series of frames to create an edit transition at the edit point.
